(19) United States
(12) Patent Application Publication
(10) Pub. No.: US 2026/0094394 A1
(43) Pub. Date: Apr. 2, 2026

(54) SKULL CARVING AND STABILIZING ALGORITHM

(71) Applicant: ELECTRONIC ARTS INC., Redwood City, CA (US)

(72) Inventors: MATHIEU LAMARRE, Montreal (CA); PATRICK ANDERSON, Montreal (CA); ETIENINE DANVOYE, Saint-Bruno-De-Montarville (CA)

(21) Appl. No.: 18/900,400

(22) Filed: Sep. 27, 2024

(51) Int. Cl. G06T 19/20; G06T 7/33; G06T 13/40; G06T 17/20

(52) U.S. Cl. CPC G06T 19/20; G06T 7/344; G06T 13/40; G06T 17/20; G06T 2207/30201; G06T 2210/12

(57) ABSTRACT

Systems and methods are provided for stabilization of rigid head motion in digital avatars. Examples include obtaining a plurality of facial expression scans of a subject, aligning the plurality of facial expression scans to a common coordinate system, and generating a stable hull based on an intersection of the plurality of facial expression scans aligned to the common coordinate system. Examples also include performing rigid stabilization of at least one facial expression scan of the subject by aligning the at least one facial expression scan to the stable hull and removing rigid transformations from the at least one facial expression scan caused by head motion of the subject.

### BACKGROUND

Facial scanning techniques may be used to create digital recreations of scanned expressions in multimedia applications. For example, facial scanning can be used to capture photorealistic likeness of a subject that can be used to generate a digital avatar of a subject for multimedia formats, such as video games, movies, on-line forums, or other multimedia formats. Facial scanning may include capturing scans of a subject as the subject performs different facial expressions. These scans can contain captured expressions overlaid on a head with undesirable rigid skull motions. Stabilization is a technique that may be used to remove this undesirable rigid skull movements to provide for true expressions that can be extracted and used to generate the digital avatars.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure, in accordance with one or more various examples, is described in detail with reference to the following figures. The figures are provided for purposes of illustration only and merely depict typical, non-limiting aspects of such examples.

FIG. 1 illustrates an example of a stabilized facial expression obtained by performing rigid stabilization of facial expression scans, in accordance with examples of the present invention.

FIG. 2 illustrates a computing component that may be used to implement rigid stabilization in accordance with various examples of the disclosed technology.

FIGS. 3A-3F illustrates an example process flow skull carving and rigid stabilization in accordance with an example of the disclosed technology.

FIG. 4 is a computing component that may be used to implement examples of the disclosed technology.

The figures are not exhaustive and do not limit the present disclosure to the precise form disclosed.

### DETAILED DESCRIPTION

The stabilization of rigid head motion included in captured facial scans is important for creation of digital assets (such as digital game assets in the context of video games) in multimedia applications that rely on photorealistic avatar construction, such as, but not limited to video games, virtual reality (VR), augmented reality (AR), movies, training data collection, and the like. In such applications, stabilization may need to be adaptable to a diverse population of subjects with varying or unique morphologies. Separating rigid head motion from facial expressions is critical for stabilization, since misalignment between rigid head motion and facial expressions can lead to difficulty in controlling animation models and cause unnaturally appearing facial motion.

Conventional stabilization methods may not be well adapted for sparse sets of very different facial expressions, as these methods often have limited accuracy, particularly in the case of upper face motions, due to reliance on a single fixed template of a head and because rest positions of a face can vary across differing morphologies.

The presently disclosed technology overcomes these shortcomings by generating a stable hull from intersections of a plurality of facial expression scans aligned to a common coordinate system and simultaneous optimizing stabilization rigid transformations directly from the plurality facial expression scans queried by the stable hull. The stable hull may comprise a polygon mesh (e.g., triangle mesh or a mesh of other polygons) that resembles a skull or a portion of a skull overlaid with minimal (e.g., negligible) soft tissue thickness. In some examples, the stable hull may resemble an upper portion of a skull and may include the upper teeth of the subject, in various examples. In examples, the plurality of facial expression scans can be aligned to a common coordinate system (sometimes referred to as a global coordinate system), and the stable hull can be computed from the intersection of the plurality of facial expression scans with respect to a reference frame. The stable hull may be generated as voxels at the intersections, and an isosurface can be extracted as a 3D shape formed as a polygon mesh representing a surface of the stable hull. Rigid stabilization of the plurality of facial expression scans can be performed by aligning the facial expression scans to the stable hull and removing rigid transformations from each facial expression scan due to rigid head movement of the subject.

As used herein, an “isosurface” refers to a 3D surface representation of points in a 3D data distribution. An isosurface may be used, for example, to represent surface voxels of a 3D shape. The voxels (e.g., a 3D pixel) or points can be joined to form a 3D surface. In some examples, an isosurface may be defined using a polygon mesh (e.g., a triangle mesh) or 3D point cloud. A polygon mesh, as used herein, refers to a collection of vertices, edges, and faces that defines a shape of a polyhedral object. The faces, in various examples, may comprise triangles (e.g., a triangle mesh), but in other examples quadrilateral or other polygons may be used.

Examples herein may obtain the plurality of facial expression scans from a variety of modalities. For example, facial expression scans can be obtained from a database storing captured facial expression scans. In another example, facial expression scans can be obtained directly from a likeness capture system. The facial expression scans, in examples disclosed herein, may be 3D facial expression scans captured from a subject (e.g., an actor or human subject) performing various facial expressions. The 3D facial expression scans may be provided as unstructured polygon meshes (e.g., triangle meshes) or 3D point clouds.

The likeness capture device in some examples may be a light stage with a multi-view camera setup that is aligned to capture facial expressions of a subject. Many facial expressions scans, which may be combinations of multiple facial action units, may be scanned using the capture device to collect 3D likeness data of the subject performing the facial expressions. The multi-view camera setup may comprise laser scanning systems configured to capture 3D point cloud data of each facial expression, RGB and depth (RGB-D) cameras to capture RGB-D likeness data of the facial expressions, or the like. However, even with a headrest, the subject's head may move when performing the various expressions, imparting undesirable rigid head motion to each facial expression. Thus, examples herein utilize a skull carving algorithm that simultaneously creates a stable hull from the plurality of facial expressions and determines rigid transformations to the stable hull that separates head motion from deformations constituting facial expressions. This separation can then be used to create a controllable digital avatars or other animation models useable for rendering in a multimedia applications (e.g., video games, movies, VR, AR, and the like).

Accordingly, examples herein simultaneously optimize rigid transformation of each facial expression scan while determining an optimal stable hull for the plurality of facial expressions. For example, a common coordinate system may be computed for the plurality of facial expression scans, which can be represented as a first bounding cube. The facial expression scans can be aligned within this first bounding cube to create a collective voxel mesh within the bounding cube. For each facial expression scan, voxels can be classified as located inside or outside of the voxel mesh, for example, as a point-in-polygon (PIP) problem. The PIP problem may be solved using any known techniques, such as, but not limited to, a crossing number algorithm or winding number algorithm. In some examples, the PIP problem is solved using a Fast Winding Number algorithm. A signed distance fields (SDF) can be computed for each facial expression scan to provide an orthogonal distance of each voxel to a boundary of the voxel mesh. SDFs can be computed using known techniques, such as but not limited to, fast marching method, fast sweeping method, and the level-set method. In an illustrative example, SDFs are computed using the fast sweeping method.

In various examples, SDF distances can be applied to a mode-pursuit algorithm to initialize rigid transformations through an initial coarse alignment of the plurality of facial expression scans to a reference facial expression mesh. In some examples, the reference facial expression mesh may be a 3D model of the subject, created by an artist or other user, with a neutral or at rest facial expression because it may be assumed that this facial expression would not include (or include minimal) rigid head movement. In another example, the reference facial expression mesh may be obtained from a facial expression scan in which the subject is performing a neutral or at rest facial expression. However, in some examples, the reference facial expression mesh may comprise any facial expression used as a reference. In either case, the reference facial expression mesh may be provided as a wire frame mesh or polygon mesh. The mode-pursuit algorithm, according to these examples, finds rigid transformations for each facial expression scan in which as many SDF distances minimized (e.g., as close to zero value as possible) with respect to the reference facial expression mesh.

Once coarsely aligned, according to some examples, a second bounding cube can be defined in which the stable hull can be computed. The second bounding cube may be smaller than the first bounding cube and may be defined by masking or otherwise excluding portions (e.g., voxels) of each facial expression scan that lie outside of the second bounding cube. For example, the second bounding cube may encompass a portion of the subject's face. In an illustrative example, the second bounding cube encompasses an upper portion of the subject's face, such as the upper teeth, forehead, eyes, nose, and zygomatic bone. In examples, the second bounding cube may be defined from the voxels of across the plurality of the coarsely aligned facial expression scans that correspond to the portion of the subject's face (e.g., upper portion in this example). By defining the second bounding cube as a portion of the subject's face (e.g., upper portion), other parts of the face that may include stronger movements that are unrelated to rigid head movement can be ignored. For example, jaw or hair movement, which can have strong movement (e.g., movement of a large magnitude) can be ignored from determining the stable hull and rigid transformations, because such movements could interfere with the optimizations used to determine the stable hull and rigid transformations. The second bounding cube may define a reference coordinate frame, in which the stable hull can be computed.

Accordingly, the stable hull can be formed as the intersections of aligned facial expression scans. That is, for example, the stable hull can be computed from intersections of the facial expressions within the second bounding cube as aligned within the first bounding cube. The aligned facial expressions may be coarsely stabilized using the mode-purist algorithm as described above, which results in intersections between each of the facial expression scans. Essentially, the stable hull is created from portions of each facial expression scan having SDF distances closest to the reference facial expression mesh. Said another way, voxels of each facial expression scan, within the second bounding cube, having distances closest to a zero value to the reference facial expression mesh relative to voxels of other facial expressions scans can be used to construct a portion of the stable hull. The collection of these voxels across the facial expression scans can collectively define the stable hull, and a polygon mesh can be extracted defining the shape of the stable hull.

At the same time, rigid transformations for each facial expression scan can be located by optimizing alignment of the facial expression scans with the stable hull. For example, each facial expression scan will have a different rigid transformation to the stable hull. While optimizing the stable hull by locating portions of each facial expression scan that are closest to the reference facial expression mesh, rigid transformations can be optimized by locating orientations of each facial expression scan that optimally aligns with to the stable hull. By considering each facial expression scan and optimizing simultaneously rigid transformations while defining the stable hull, each facial expression scan can be optimally aligned across the whole set of facial expression scans.

In some embodiments, the stable hull can be computed as the zero isosurface of a maximum function over all facial expression scan SDFs. The isosurface can be extracted using differentiable isosurface extraction techniques, in some examples, which makes it possible to optimize both the stable hull shape and rigid stabilization transformations at the same time. Examples of differentiable isosurface extraction techniques include, but are not limited to, the FlexiCube differentiable method, the Deep Marching Tetrahedra extraction method, the Meshsdf method, and the DeepMesh method, to name a few examples. A skull carving gradient descent optimization can run on the SDFs, for example, by minimizing a mean stable hull zero-distance histogram mode to SDFs of each facial expression scan. Through this optimization, the facial expression scans can be stabilized by removing the unwanted rigid skull motions, thereby providing motions representative of true facial expressions absent of skull induced motion.

By leveraging SDFs and differentiable isosurface meshing to compute skull stabilization rigid transformations directly from the facial expression scans, the disclosed technology may enhance accuracy and robustness of the rigid skull stabilizations. The disclosed skull carving algorithm can optimize both the stable hull shape and skull stabilization rigid transformations simultaneously to obtain accurate stabilization across a multitude of facial expression scans for a diverse set of subjects (e.g., varying morphology), outperforming the conventional approaches.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

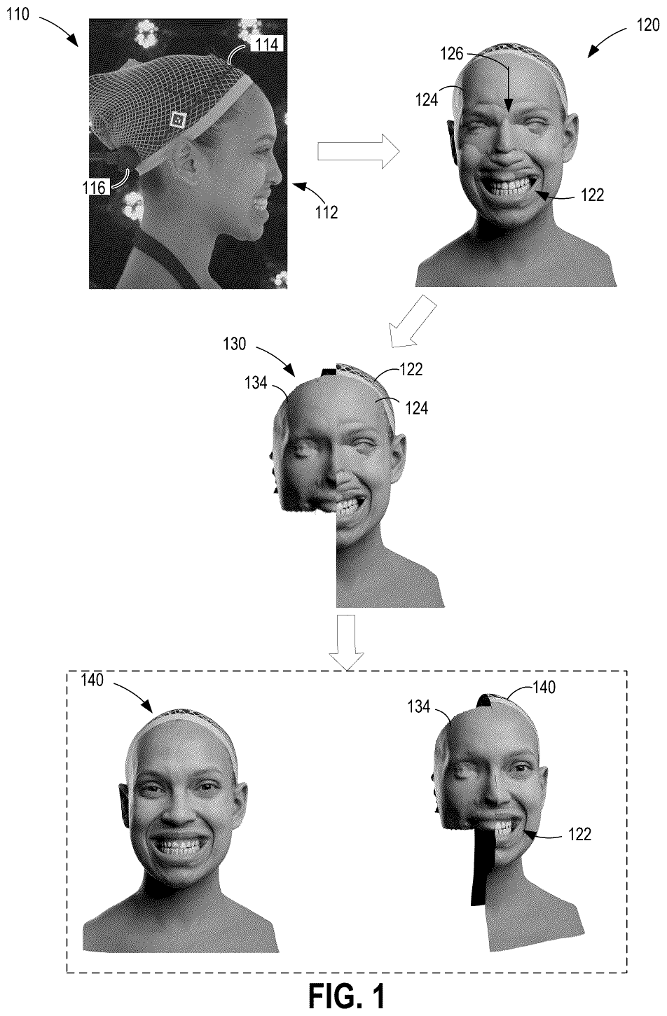

FIG. 1 illustrates an example of a stabilized facial expression obtained by performing rigid stabilization of facial expression scans, in accordance with examples of the present invention. FIG. 1 illustrates a screen shot 110 of subject 114 performing a facial expression, which can be captured to produce a facial expression scan 120. The subject 114 may be acting out a facial expression by deforming the subject's face.

In some examples, a likeness capture device may be used to capture the likeness scan data while the subject 114 is performing the facial expression. In examples, the likeness capture device may be a light stage with a multi-view camera setup aligned to capture 360 degree views of the subject 114. The multi-view camera setup may include multiple cameras, such as RGB-D cameras (or other imaging devices, such as LiDAR systems), configured to capture a 360 degree view of the subject 114. The multi-view camera setup may capture 3D point cloud data or the like, from which a facial expression scan can be obtained. In examples, the likeness scan data may be used to construct a 3D facial expression scan, which in some examples may be a 3D model of the captured facial expression performed by the subject 114. The 3D facial expression scan in some examples may be a polygon mesh (e.g., a triangle mesh) or a 3D point cloud. FIG. 1 depicts an example facial expression scan 120 provided as a 3D polygon mesh.

In some examples, the likeness scan data may comprise 4D facial expression scans. 4D facial expression scans may refer to an instance in which 3D facial expression scans are capture in a sequence to provide a video in which each 3D facial expression scan represents a 3D frame of the video.

As described above, when scanning subjects performing various facial expressions, the resulting facial expression scans can include both facial expression movement (e.g., facial deformations) as well undesirable rigid head motion. The head motion may be caused by the subject's inability to keep their head perfectly still while performing a wide range of expressions, even when a headrest 116 is employed. As a result, facial expression scans can contain desired facial expression 122 superimposed on undesirable rigid motion. FIG. 1 illustrates this rigid motion as a deviation of the facial expression 122 from a reference head position 124 in the facial expression scan. As shown by arrow 126, rigid head movement deviated in a downward direction.

The inclusion of the reference head position 124 is for non-limiting illustrative purposes only. Facial expression scans, such as facial expression scan 120 may not include a visual representation of the reference head position, but include the rigid motion superimposed with the facial expression 122.

Examples herein automatically rigidly align facial expression scans to a common frame of reference and extract true facial expressions of the subject by factoring out rigid motion of the head included in the facial expression scans. For example, FIG. 1 illustrates that, for facial expression scan 120, the rigid motion can be factored out by defining a stable hull 134 and applying a rigid transformation that shifts facial expression scan 120 to the stable hull 134 to produce a stabilized facial expression scan 140. As will be detailed below, the stable hull 134 can be generated from intersections of a plurality of facial expression scans-facial expression scan 120 being just one example included in the plurality of facial expression scans-aligned to a common coordinate system.

Stabilized facial expression scans can be extracted by computing rigid transformations directly from the facial expression scans that are aligned and stabilized to the stable hull 134 as a common frame of reference. For example, as shown in FIG. 1, a stable hull 134 can be generated and facial expression scan 120 overlaid on the stable hull 134, as shown in the cross-sectional view 130 of facial expression scan 120. The facial expression scan 120 can be aligned and stabilized by optimizing the deviation between an isosurface of the facial expression scan with respect to the isosurface of the stable hull 134. Optimizing in this case may refer to minimizing the overall distance between voxels of the facial expression scan 120 and voxels of the stable hull 134. For example, as shown in the stabilized facial expression scan 140 and its corresponding cross sectional view, the overall deviation between isosurfaces of the facial expression scan and the stable hull 134 are minimized. Once stabilized and aligned, the true facial expression can be extracted as a 3D shape (or 3D model) embodied by the stabilized facial expression scan 140. The 3D shape may be extracted as a 3D polygon mesh or 3D point cloud.

In various examples, the stable hull 134 may resemble a skull or a portion of a skull overlaid with minimal (e.g., negligible) soft tissue thickness. In some examples, the stable hull 134 may resemble an upper portion of a skull and may include the upper teeth of the subject, as shown in FIG. 1. In examples, a plurality of facial expression scans, such as including facial expression scan 120, can be aligned to a common coordinate system and the stable hull 134 can be computed from the plurality of facial expression scans. In examples, a stable hull 134 can be computed from a facial expression scans of a single subject (e.g., subject 114). As such, the stable hull can be considered a subject-specific stable hull. Other stable hulls may be computed on a per-subject basis from facial expression scans for each respective subject.

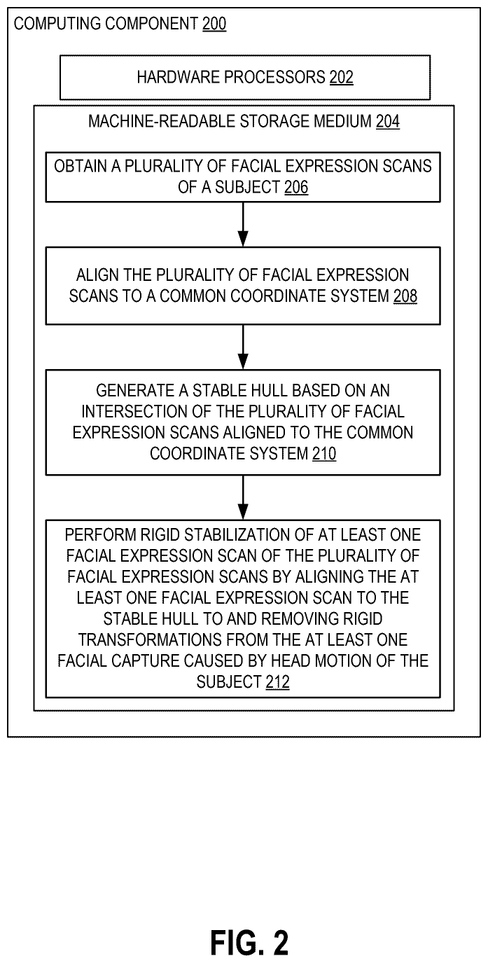

FIG. 2 illustrates a computing component that may be used to implement rigid stabilization in accordance with various examples of the disclosed technology. Referring now to FIG. 2, computing component 200 may be, for example, a server computer, a controller, or any other similar computing component capable of processing data. In the example implementation of FIG. 2, the computing component 200 includes a hardware processor 202, and machine-readable storage medium 204.

Hardware processor 202 may be one or more central processing units (CPUs), semiconductor-based microprocessors, and/or other hardware devices suitable for retrieval and execution of instructions stored in machine-readable storage medium 204. Hardware processor 202 may fetch, decode, and execute instructions, such as instructions 206-212, to control processes or operations of skull carving and rigid stabilization disclosed herein. As an alternative or in addition to retrieving and executing instructions, hardware processor 202 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 204, may be any electronic, magnetic, optical, or other physical storage device that contains or stores executable instructions. Thus, machine-readable storage medium 204 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 204 may be a non-transitory storage medium, where the term “non-transitory” does not encompass transitory propagating signals. As described in detail below, machine-readable storage medium 204 may be encoded with executable instructions, for example, instructions 206-212.

Hardware processor 202 may execute instruction 206 to obtain a plurality of facial expression scans of a subject. For example, as described above in connection with FIG. 1, a plurality of facial expression scans of a subject performing facial deformations can be captured as by a likeness capture device. The plurality of facial expression scans can be stored to a data store as a set of facial expression scans. Each facial expression scan can may be provided as a 3D point cloud or polygon (e.g., triangle mesh) representing a 3D shape of each facial expression. The 3D shape of each facial expression can may comprise voxels defining the 3D shape and an isosurface defined by the polygon mesh or 3D point cloud, in either example. The facial expression scans can contain both facial expression movement (e.g., facial deformations) as well undesirable rigid motion of the subject's head while performing the facial deformations.

Hardware processor 202 may execute instruction 208 to align the plurality of facial expression scans to a common coordinate system. For example, bounding cubes can be computed for each facial expression scan that contains the entirety of the head of each facial expression scan. In some examples, the neck and part of the upper torso of the subject may be included to ensure the entire head is contained in the bounding cubes. The bounding cubes may be aligned to define a common coordinate system for the plurality of facial expression scans. By aligning the bounding cubes, the plurality of facial expression scans can be aligned and superimposed on each other, resulting in a collective voxel mesh (sometimes referred to as a scan mesh).

In some examples, hardware processor 202 may execute instruction 208 to create the voxel mesh of the plurality of facial expression scans within in the bounding cube by aligning the plurality of facial expression within the common coordinate system. Each voxel of a given facial expression scan can be classified as located inside or outside of the voxel mesh, for example, as a PIP problem. The PIP problem may be solved using any known techniques, such as, but not limited to, a crossing number algorithm or winding number algorithm. In some examples, the PIP problem is solved using a Fast Winding Number algorithm.

In some examples, hardware processor 202 may execute instruction 208 to compute SDFs for each facial expression scan. The SDFs provide, for each facial expression scan, an orthogonal distance between each voxel to a boundary of the voxel mesh. SDFs can be computed using known techniques, such as but not limited to, fast marching method, fast sweeping method, and the level-set method.

In some examples, the PIP problem and SDFs for each facial expression scan can be solved in parallel with one or more other facial expression scans. That is, for example, two or more facial expression scans can be processed at the same time to determine whether voxels are inside or outside of the voxel mesh and compute SDFs for each facial expression scan. In some examples, the plurality of facial expression scans can be processed in parallel. In another examples, each facial expression scan can be processed one after another.

Additionally, in some examples, hardware processor 202 may execute instruction 208 to convert the SDFs of each facial expression scan to a reduced SDF in terms of file size. For example, instruction 208 may approximate each SDF using a tri-plane based neural SDF model that feeds tri-plane features to a multi-layer perception (MLP). The resulting SDF is an approximation of the true SDF that is more compact in terms of size and enables increased computation efficiency. While certain examples are disclosed herein, any method of approximating the true SDF may be used, as long sub-millimeter accuracy can be obtained by the resulting SDF. The resulting SDF, therefore, can be compact and fast to evaluate on a graphical processing unit (GPU).

In some examples, instruction 208 may be executed to compute SDFs for 4D facial expression scans. For example, instruction 208 may be executed as described above, but a time variable (t) may be added to the computations to extend support to 4D facial expression scans (e.g., videos).

Hardware processor 202 may execute instruction 210 to generate a stable hull based on intersections of the plurality of facial scans aligned to the common coordinate system. The stable hull may resemble a skull or a portion of a skull overlaid with minimal (e.g., negligible) soft tissue thickness. In some examples, the stable hull may resemble an upper portion of a skull and may include the upper teeth of the subject, in various examples. An isosurface of the intersections can be extracted as a 3D shape representing the stable hull.

In some examples, hardware processor 202 may execute instruction 210 to initialize rigid transformations using the SDFs generated at instruction 208, either the full, true SDF or the approximated SDF. Instructions 210 may execute a mode-pursuit algorithm on the SDF distances to find a coarse rigid transformation for each facial expression that causes as many SDF distances as possible to approximately align a reference facial expression mesh. In some examples, the reference facial expression mesh may be a 3D model of the subject with a neutral or at rest facial expression, while in other examples the reference facial expression mesh may comprise any facial expression used as a reference. In either case, the reference facial expression mesh may be provided as a wire frame mesh or polygon mesh. Instructions 210 may execute the mode-pursuit algorithm, according to these examples, to find rigid transformations for each facial expression scan in which as many SDF distances are minimized (e.g., as close to zero value as possible) with respect to the reference facial expression mesh.

In some examples, hardware processor 202 may execute instruction 210 to create a reference bounding cube in which the stable hull can be computed. The reference bounding cube (sometimes referred to herein as a “second bounding cube”) may be smaller than the bounding cube that defines the common coordinate system. For example, the reference bounding cube created by instruction 210 may encompass a portion of the subject's face. In an illustrative example, this reference bounding cube encompasses an upper portion of the subject's face, such as the upper teeth, forehead, eyes, nose, and zygomatic bone. In examples, the reference bounding cube may be defined so to contain the voxels of across the plurality of the facial expression scans, having been coarsely aligned as described above, that correspond to the portion of the subject's face (e.g., upper portion in this example).

In examples, instructions 210 may cause hardware processor 202 to compute the stable hull from intersections of the facial expression scans within the reference bounding cube as aligned based on the first bounding cube. The aligned facial expression sans may be coarsely stabilized using the mode-purist algorithm above, which results in intersections between each of the facial expression scans. For example, the stable hull is created from portions of each facial expression scan having SDF distances closest to the reference facial expression mesh. That is, for example, voxels of each facial expression scan, within the second bounding cube, having distances closest to a zero value to the reference facial expression mesh relative to voxels of other facial expressions scans can be used to construct a portion of the stable hull. The collection of these voxels across the facial expression scans can collectively define the stable hull, and a polygon mesh can be extracted defining the shape of the stable hull.

Accordingly, the stable hull can be computed as the zero isosurface of a maximum function over all facial expression scan SDFs. The isosurface can be extracted with using differentiable isosurface extraction techniques (e.g., the FlexiCube differentiable method, the Deep Marching Tetrahedra extraction method, the Meshsdf method, the DeepMesh method, and other methods of the like), in some examples, which makes it possible to optimize both the stable hull shape and rigid stabilization transformations at the same time.

Hardware processor 202 may execute instruction 212 to perform rigid stabilization of at least one facial expression scan of the plurality of facial expression scans by aligning at the least one facial expression scan to the stable hull, which removes rigid transformations from the at least one facial one facial expression scan caused by head motion of the subject. For example, as described above, rigid stabilization transformations can be computed from the facial expression scan SDFs, at the same time as computing the stable hull shape. A skull carving gradient descent optimization can run on the SDFs, for example, by minimizing a mean stable hull zero-distance histogram mode to SDFs of each facial expression scan. Through this optimization, the facial expression scans can be stabilized by removing the unwanted rigid motions by orientating the least one facial expression scan, thereby providing facial deformations representative of true facial expressions absent of skull induced motion. In examples, rigid transformations can be determining for each of the plurality of facial expression scans simultaneously through the optimization process, thus providing for rigid stabilization of the entire set of facial expression scans.

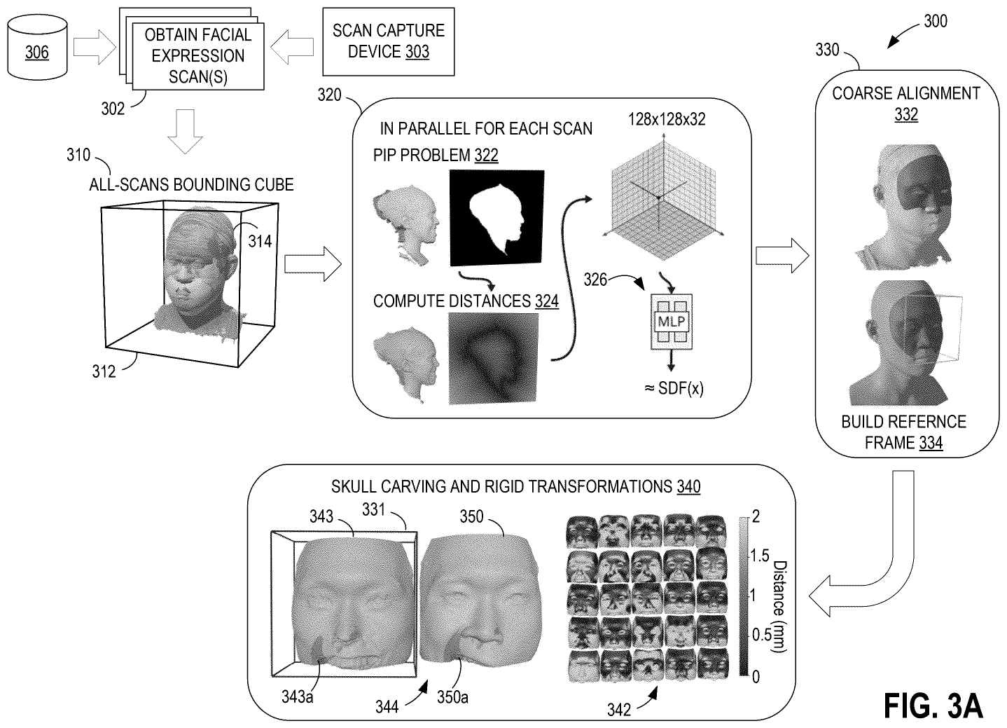

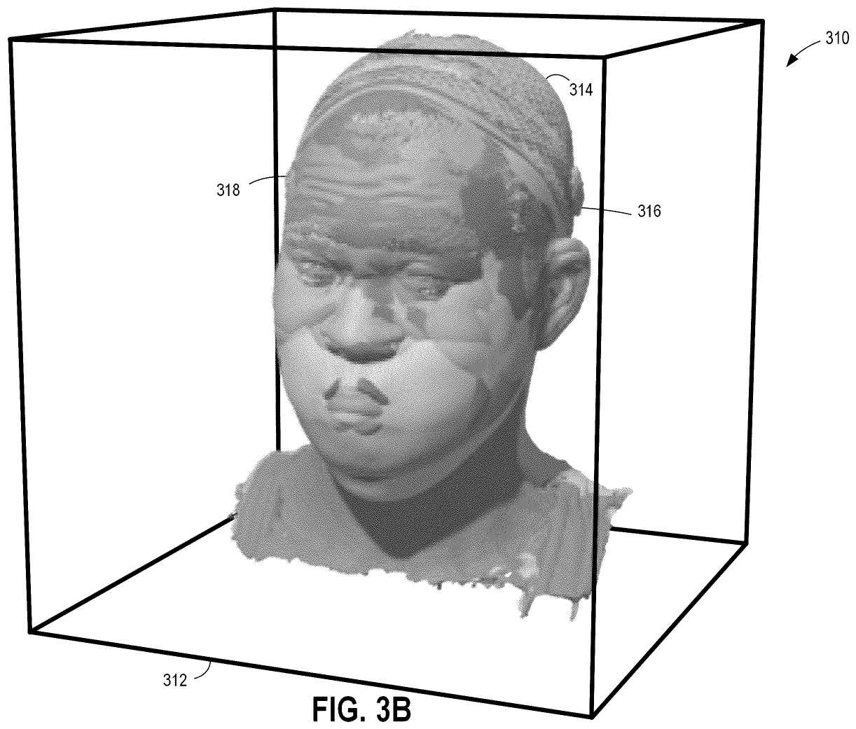

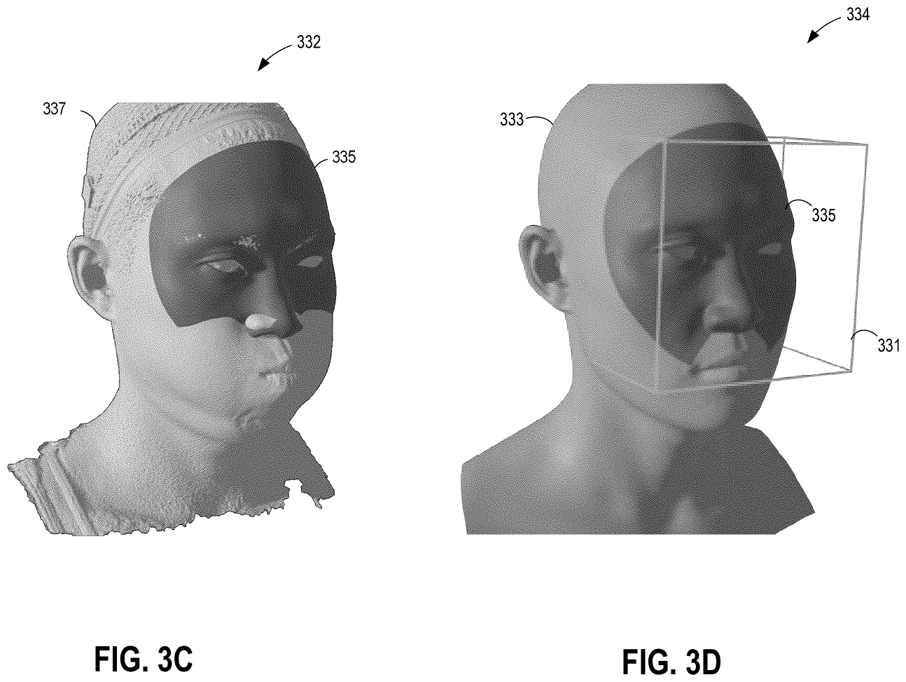

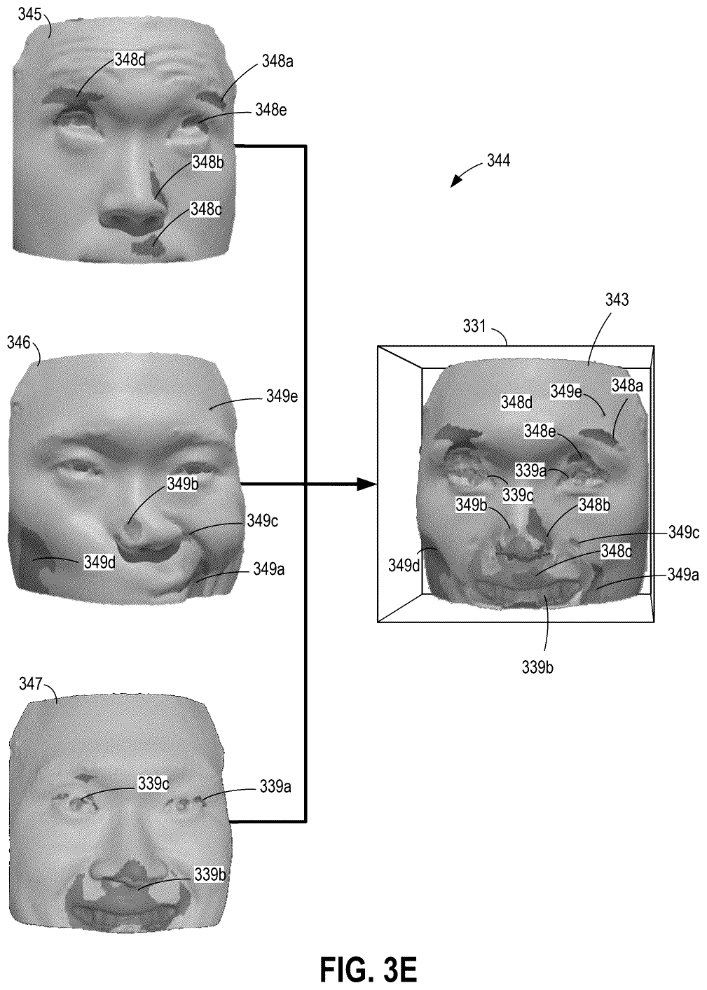

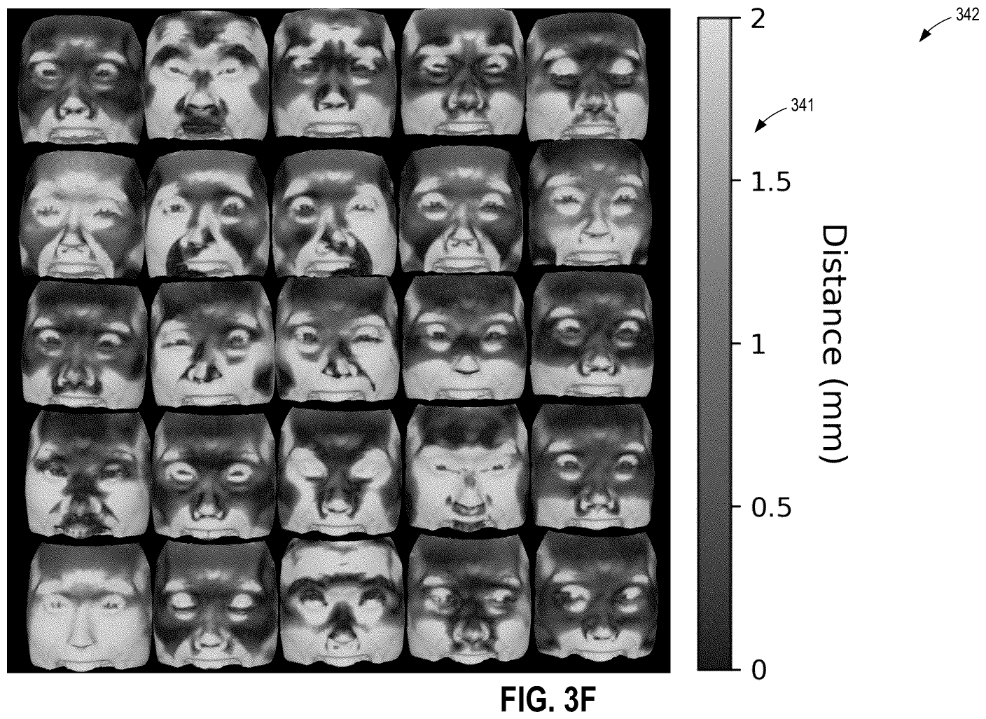

FIGS. 3A-3F illustrate an example process for flow skull carving and rigid stabilization in accordance with an example of the disclosed technology. In examples, process 300 may be implemented as machine-readable instructions that may cause a processor to perform the operations described herein. In some examples, computing component 200 may be implemented to execute one or more operations disclosed herein.

At operation 302, a plurality of facial expression scans can be obtained. For example, operation 302 may retrieve the plurality of facial expression scans from a data store 301 storing captured facial expression scans. In another example, operation 302 may receive the scans from likeness capture device 303, as described above. Each facial expression scan can be provided as a 3D shape of a respective facial expression, including undesirable rigid motion. The 3D shape may be defined as an array of voxels (also referred to as a “voxel array”).

To convert raw facial expression scans to SDF, operation 310 may compute a bounding cube 312 of all raw facial expression scans. For example, a bounding cube for each raw facial expression scan can be computed that bounds the voxel array of a given facial expression scan. Each bounding cube can then be aligned to other bounding cubes to define a common coordinate system, such that bounding cube 312 results from the overlapping and alignment of the individual bounding cubes. Using the bounding cube 312, the voxel arrays for each facial expression scan can be aligned to a common coordinate system. The voxel arrays can be superimposed on each other to create a voxel mesh 314, which represents a single 3D body comprising of all voxels for each facial expression scan. FIG. 3B depicts a close up view of the voxel mesh 314, in which regions of different levels of grey represent voxels corresponding to distinct facial expression scans. As an illustrative example, region 316 may corresponding voxels of one facial expression scan, while region 318 correspond to voxels of another facial expression scan. Thus, the voxel mesh 314 comprises voxels corresponding to the plurality of facial expression scans.

At operation 320, each voxel of each facial expression scan is compared to the voxel mesh 314 to determine if the voxel is located inside or outside of the voxel mesh 314 at sub-operation 322. Sub-operation 322 may be executed as a as a PIP problem, which can be solved using known techniques, such as but not limited to, a crossing number algorithm or winding number algorithm. In the example of FIG. 3A, sub-operation 322 executes a Fast Winding Number method to determine whether each voxel of a given facial expression scan is inside or output of the voxel mesh 314.

Operation 320 may also include sub-operation 324 to compute an orthogonal distance between each voxel of each facial expression scan to a boundary of the voxel mesh 314. Sub-operation 322 may be performed by computing SDFs for each facial expression scan. SDFs can be computed using known techniques, such as but not limited to, fast marching method, fast sweeping method, and the level-set method. In the example of FIG. 3A, sub-operation 322 may execute the fast sweeping method to compute orthogonal distances.

In some examples, to implement a computationally efficient stabilization process (e.g. process 300), SDFs for each facial expression scan may need to be as compact as possible to permit efficient evaluation by computation resources (e.g., a GPU). For example, the plurality of facial expression scans being stabilized may include between 10 and 100 or more facial expression scans. Voxel array evaluations can be fast, but even at low bit depth they may require monopolizing more computation resources than desired (e.g., that may require more memory than available or desired to permit other operations to proceed) to stabilize the plurality of facial expressions scans, particularly where 100 or more facial expression scans are processed. Accordingly, process 300 includes an optional sub-operation 326, in which a tri-plane based neural SDF model is executed to compute an approximation of the true, full SDF for each facial expression scan. The approximation may result in SDFs that are reduced in size (e.g., in terms of memory) which is sufficiently close to true, full SDF. For example, sub-operation 326 may include feeding an output of 128×128×32 tri-plane features to a single MLP, which outputs a resulting SDF that has sub-millimeter accuracy. In an example, the MLP may comprise two hidden layers of 196 neurons and ReLu activation function. Examples herein train distinct parameters θᵢ of tri-plane based neural SDF model φ to approximate each facial expression scan SDFᵢ over the entire boundary Ω of the voxel mesh 314 as follows:

$${ϕ}_{{θ}_{i}} \approx {SDF}_{i} ( x ) , {∀}_{x} ∈ Ω \qquad Eq . 1$$

where x represents a position in 3D space within the bounding box 312. That is, for example, the neural SDF model φ, having parameters θᵢ, is approximate to the true SDF for each facial expression scan (e.g., SDFᵢ) as function of positions in 3D space within the bounding box 312, for all positions that is an element of the bounding box volume (Ω). This example model can be evaluated quickly and requires relatively little memory (e.g., less than 1% of the memory consumed to perform conventional approaches). As used herein, “quickly” may refer an amount of time for a GPU to do three bilinear samples and evaluate a small neural network. Examples herein may be capable of performing a one million point query in 10 milliseconds. Examples disclosed herein may provide constant complexity with big O notation O (C), which may be faster than using an acceleration structure that would be O (log N) when N is large. As another example, an 800³ voxel array of float32 may consume 2000 MB of memory, while the examples disclosed herein may consume 6 MB of memory.

In some examples, SDFs may be computed from 4D facial expression scans. For example, operation 325 may be extended to include a time variable (t) to support to 4D facial expression scans (e.g., videos). That is, where a facial expression scan may be represent as f(x,y,z), a 4D facial expression scan may be represented as represent as f(x,y,z,t). Thus, a 4D facial expression scan may comprises a number of 3D facial expression scans (e.g., frames of video) as a function of time. The operations described herein may be similar for 4D facial expression scans as 3D facial expression scans, in that each frame (e.g., each 3D facial expression of a 4D facial expression scan) can be treated as a single 3D facial expression scan while tracking variable t throughout the process 300.

Rigid transformations of the facial expression scans can be initialized at operation 330. Operation 330 may execute a coarse head alignment that initially aligns facial expressions, captured in each facial expression scan, to a reference frame. Coarse head alignment can be used to account for relatively large head movements (e.g., head movements of 1 or more centimeters, such as 2 cm or more) that can cause a non-convex energy function (also referred to herein as a “penalty function”). Equation 4 below provides an example of energy function in accordance with the examples disclosed herein. Non-convex, in the context of numerical optimization, refers to a function that has multiple local minima. In the examples disclosed herein, coarsely head alignment at operation 330 may operate to avoid getting stuck in a local minima by coarsely aligning the facial expression to a global minima.

In examples, coarse head alignment achieved by aligning each of the facial expressions scan to a reference frame (sub-operation 332) and defining a reference bounding cube (sub-operation 334). For example, sub-operation 332 may include retrieving a reference facial expression mesh of the subject performing a neutral or at rest facial expression (referred to herein as a “reference facial expression mesh”) and coarsely align each facial expression scan to the reference facial expression mesh. Then, at sub-operation 334, a reference bounding cube can be defined in which the stable hull can be computed. In examples, the reference bounding cube may be defined so to encompass all voxels of an upper portion of the subject's face across the facial expression scans having been coarsely aligned during sub-operation 332.

In some examples, the reference facial expression mesh may be a 3D model of the subject. The 3D model may be created by an artist or other user or obtained from a facial expression scan in which the subject is performing a neutral or at rest facial expression. In some examples, the reference facial expression mesh need not be a neutral or at rest facial expression and may comprise any facial expression used as a reference. In either case, the reference facial expression mesh may be provided as a wire frame mesh or polygon mesh.

FIG. 3C depicts an illustration of an example sub-operation 332 in which a facial expression scan 337 can be aligned with reference facial expression mesh 335. In this case, the reference facial expression mesh 335 comprises certain features (e.g., eyes, nose, zygomatic bone, and forehead) that can be used to coarsely align the facial expression scan 337, which may contain a non-neutral facial expression, with the reference facial expression mesh 335. In an illustrative example, a mode-pursuit algorithm can be applied to the SDF distances, determined during sub-operation 324, for coarse alignment. The mode-pursuit algorithm, according to these examples, finds a rigid transformation for facial expression scan 337 in which as many SDF distances for a subset of voxels of facial expression scan 337 are minimized (e.g., as close to zero value as possible) with respect to the reference facial expression mesh 335. The subset of voxels of facial expression scan 337, in this example, may be those voxels that correspond to the features contained in the reference facial expression mesh 335. The mode-pursuit algorithm seeks to maximize the number of mesh vertices with near zero SDF distance by using an energy function that considers only the subset of vertices with SDF distance smaller than a specified threshold (e.g., 5 cm as an example, although any desired threshold may be applied as an initial specified threshold). Optimization can be carried to convergence, at which point the threshold can be reduced, such as 4 cm in some examples (however, any desired subsequent threshold may be applied). The optimization and reduction of the threshold can be repeated a number of times until the threshold is sufficiently small. In the case of facial animation, a threshold of 0.5 mm may be an example of a sufficiently small threshold. However, any distance as desired may be considered sufficiently small depending the application. The resulting rigid transformation maximizes the zero-distance bin in the distance histogram. This resulting rigid transformation may be used as an initial transformation applied to facial expression scan 337.

While FIG. 3C is described with reference to a single example facial expression scan, sub-operation 332 can be applied to each facial expression scan obtained by process 300. Thus, initial rigid transformations for each facial expression scan can be obtained that provide a coarse alignment of the facial expressions relative to the reference facial expression mesh 335.

FIG. 3D depicts an illustration of an example sub-operation 334 in which a reference bounding cube 331 is shown superimposed on a reference facial expression mesh 335. FIG. 3D depicts the reference facial expression mesh 335 positioned on a 3D model 333 from which the reference facial expression mesh 335 was extracted, as described above. In examples, the reference bounding cube may be defined so to contain the voxels of the coarsely aligned facial expression scans (sub-operation 344) of each of the plurality of facial expression scans. In the illustrative example of FIG. 3D, the reference bounding cube 331 encompasses voxels corresponding to the upper teeth, forehead, eyes, nose, and zygomatic bone of the subject as shown in the 3D model 333. Additionally, this reference bounding cube 331 can be defined to include corresponding voxels from the plurality of facial expression scans (e.g., facial expression scan 337, as well as others not shown in FIGS. 3C and 3D). In examples, the stable hull and rigid transformations can be computed within the reference bounding cube.

The reference bounding cube may function as a mask that separates the portion of the subject's face from other portions of the subject that may experience stronger movements unrelated to the undesirable rigid head movements. For example, lower jaw or hair movement, which can have strong movements (e.g., movement of a large magnitude) can be ignored from downstream stable hull and rigid transformations determinations. These stronger movements could interfere with the optimizations used to locate an optimal stable hull and rigid transformations. Thus, the reference bounding cube 331 can be defined to exclude such movements from the downstream operations.

Once initialized at operation 330, the stable hull and rigid transformations, for each facial expression scan, can be determined at operation 340. For example, skull carving can be executed to compute the stable hull from intersections of the facial expression scans within the reference bounding cube (sub-operation 344) by optimizing distances (e.g., minimizing) between vertices of facial expression scans and the vertices of the reference facial expression mesh (sub-operation 342). Vertices in this case may refer to a vertex of a polygon mesh, which may be connected by edges to form a face. For example, the coarsely aligned facial expression scans from sub-operation 332 can results in intersections between each of the facial expression scans within the reference bounding box 331. The stable hull can be formed from portions of each facial expression scan having SDF distances that are optimally closest to the reference facial expression mesh. In other words, vertices of each facial expression scan, within the second bounding cube, having distances closest to a zero value to the reference facial expression mesh relative to vertices of other facial expressions scans can be used to construct a portion of the stable hull. The collection of these voxels across the facial expression scans can be aggregated and stitched together to define the stable hull. A polygon mesh can be extracted defining a 3D shape of the stable hull. FIG. 3A illustrates a stable hull 343 formed in reference bounding cube 331 and a facial expression scan 350. In the example of FIG. 3A, portions 350a of facial expression scan 350 may be used to form corresponding portions 343a of the stable hull.

Sub-operation 344 determines rigid transformations for each facial expression scan by optimizing alignment of each respective facial expression scan with the stable hull 343. For example, each facial expression scan will have a different rigid transformation to the stable hull 343. While optimizing the stable hull by locating portions of each facial expression scan that are closest to the reference facial expression mesh, rigid transformations can be optimized by locating orientations of each facial expression scan that optimally aligns with to the stable hull 343. As described below, sub-operation 344 may be executed using a variation of the mode-pursuit algorithm described above. By considering each facial expression scan and optimizing simultaneously rigid transformations while defining the stable hull, each facial expression scan can be optimally aligned across the whole set of facial expression scans, as shown in FIG. 3A.

In more detail, skull carving at sub-operation 344 can be executed as a non-linear optimization problem solved with gradient descent. To model rigid transformations, sub-operation 342 may use unit dual quaternions, which may be well suited for numerical optimization. Skull carving (sub-operation 344) can be implemented by taking a maximum distance over all stabilized facial expressions scans from sub-operation 342. If, for vertices in stabilized space, the maximum distance to any vertex of a given facial expression scan is positive, this vertex can be considered outside of the stable hull 343. In this case, γ may be represent a differentiable isosurface extraction function of a differentiable isosurface extraction technique (e.g., the FlexiCube differentiable method, the Deep Marching Tetrahedra extraction method, the Meshsdf method, the DeepMesh method, and other methods of the like) that turns voxels of the stable hull 343 into a polygon mesh (e.g., vertices, edges, and polygon faces). The polygon mesh, in various examples, can be a triangle mesh. The function γ may take a scalar field (e.g., an SDF or, in other words, a volumetric function that returns a scalar-single value, such as f(x,y,z)=d, where d represents a distance) as an input and may output vertex positions of the polygon mesh defining 3D surface of the stable hull 343. In some examples, the differentiable isosurface extraction technique may also output the vertex indices, which can be useful for visualization but are not necessary during optimization.

The stable hull 343 can be defined as a stable hull function in reference frame [symbol] , which can be provided as:

$$𝒮 ( Q ) = γ ( {max}_{i ∈ [ N ]} {ϕ}_{{θ}_{i}} ( {q}_{i} {X}_{r} \overline{{q}_{ι}} ) ) \qquad Eq . 2$$

where Q represents a set of stabilization dual quaternions and Xᵣ represents an array of voxel points in the neutral reference frame. The initial rigid transform can be identified and matched with the SDF of the reference facial expression mesh (e.g., sub-operation 330 to initialize operation 340). The set of stabilization dual quaternions can be provided as:

$$Q = {\{ {q}_{1} = 1 , {q}_{1} \}}_{i = 2}^{N} \qquad Eq . 3$$

where q₁ represents a first rigid transformation in a dual-quaternion; a first facial expression scan is the neutral facial expression, its rigid transformation being identity (e.g., 1); N represents a number of facial expression scans; and the i represents an index of facial expression scans. With ψ representing the [symbol] 0 norm that approximates a penalty function (e.g., the non-convex energy function) of the mode-pursuit algorithm, the optimization process can be provided as:

$$arg {min}_{Q} \frac{1}{N} {\sum }_{i = 1}^{N} ψ ( {ϕ}_{{θ}_{i}} ( {q}_{i} 𝒮 ( Q ) \overline{{q}_{ι}} ) ) \qquad Eq . 4$$

Equations 1-4 can be implemented in, as, or among one or more machine learning based frameworks: which may include one or more machine learning models and/or deep learning models.

In some embodiments, operation 340 may implement a two-step mode-pursuit algorithm. For example, operation 340 may first optimizing Eqs. 1-4 with a first histogram bin size and then optimizing Eqs. 1-4 using a second histogram bin size. For example, the first histogram bin size may be 2 mm and then second may be 1 mm. However, examples herein may be implemented using an m-step mode-pursuit schedule, where m is an integer greater than one. Furthermore, any desired histogram bin size may be utilized depending on the desired application. In an example, Xr may have a size of 40³ voxels, but in some examples an additional mask can be used to ignore voxels that exceed a threshold distance either inside or outside of the reference facial expression mesh during initialization at operation 330, which can accelerate computations by ignoring unneeded voxels. The threshold distance may be set as a distance sufficiently far from the boundary surface of the reference facial expression mesh to be considered not part of the stable hull. In an example, the threshold distance may be +/−4 mm, but other thresholds may be used according to the desired application. The masked voxels may have fixed signed distance and are considered to not influence the stable hull.

FIG. 3E illustrates an example of operation 344 in which the stable hull is constructed from coarsely aligned facial expression scans. For example, stable hull 343 can be constructed within reference bounding cube 331 through skull carving as described above. Through optimization of Eqs. 1-4, portions of each facial expression scans, determined to be closest to the reference facial expression mesh, can be identified and used to create the stable hull 343. As illustrative examples, FIG. 3E depicts portions of coarsely aligned and stabilized facial expression scans 345-347. Each facial expression scans 345-347 comprises voxels that are closest to the reference frame (e.g., a zero distance) relative to voxels of other facial expressions scans, as determined through execution of Eqs. 1-4. For example, facial expression scan 345 comprises regions 348a-348e having voxels that are optimally close to the reference facial expression mesh (e.g., SDF of the facial expression matches the SDF of the reference facial expression mesh); facial expression scans 346 comprises regions 349a-349e; and facial expression scans 347 comprises regions 339a-339c.

These regions can be identified from their respective facial expression scans and used as voxels to construct the stable hull 343. For example, as shown in FIG. 3E, voxels of regions 348a-e, 349a-e, and 339a-c can be used to form respective regions of the stable hull 343. FIG. 3E illustrates an example in which three coarsely aligned and stabilized facial expression scans are used for illustrative purposes only. Examples herein accumulate voxels from a multitude of stabilized facial expression scans to create the full stable hull 343 shown in FIG. 3E. Once the voxels of the stable hull are defined, the stable hull can be extracted as described above.

FIG. 3F depicts the visualization of sub-operation 342, shown in FIG. 3A, for which optimal rigid transformations can be determined through executing operation 340. In the example of FIG. 3F, an illustrative subset of facial expression scans are shown (e.g., 25 scans in this example), each of which have been optimally stabilized with respect to the stable hull 343 by optimizing Eqs. 1-4 above. In this case, optimization comprises finding relative positions of each facial expression scan to the stable hull 343 that minimizes SDF distances for a given facial expression scan, as well as optimally minimizes the SDF distances for all other facial expression scans. On the right side of FIG. 3F, a legend 341 provides distances in millimeters represented using gradient greyscale, where the darker grey corresponds to smaller distances between vertices of the facial expression scan and the stable hull and lighter grey corresponds larger distances.

While the example of FIG. 3F shows a certain number of facial expression scans, the technology disclosed herein is not limited to this specific number. Any number of facial expression scans may be used, and the example 25 scans shown here are for illustrative purposes only.

Accordingly, the stable hull and the rigid transformations for each facial expression scan be determined at the same time through optimizing the SDF distances of each facial expression scan. The optimization can computes a stable hull for the plurality of facial expression scans, while simultaneously determining rigid transformations for each facial expression scan that removes undesired rigid motion due to movement of the head relative to the stable hull.

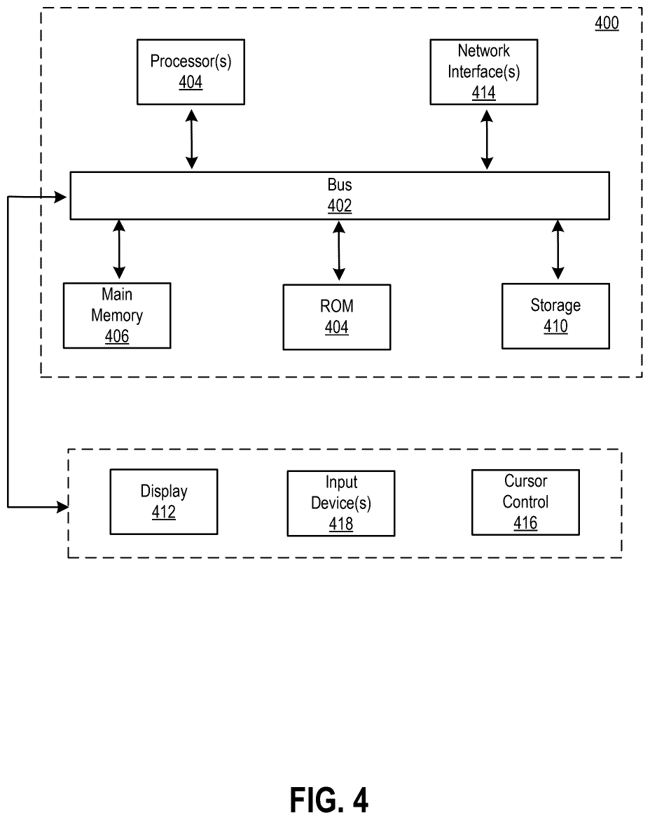

FIG. 4 depicts a block diagram of an example computer system 400 in which various examples of the disclosed technology described herein may be implemented. The computer system 400 includes a bus 402 or other communication mechanism for communicating information, one or more hardware processors 404 coupled with bus 402 for processing information. Hardware processor(s) 404 may be, for example, one or more general purpose microprocessors. The computer system 400 may be implemented as one or more component of the computing component 200 of FIG. 2.

The computer system 400 also includes a main memory 406, such as a random access memory (RAM), cache and/or other dynamic storage devices, coupled to bus 402 for storing information and instructions to be executed by processor 404. Main memory 406 also may be used for storing temporary variables or other intermediate information during execution of instructions to be executed by processor 404. Such instructions, when stored in storage media accessible to processor 404, render computer system 400 into a special-purpose machine that is customized to perform the operations specified in the instructions. For example, main memory 406 may store instructions, that when executed by processor(s) 404, cause computer system 400 to perform one or more of the operations described in connection with FIGS. 2 and 3A-3F.

The computer system 400 further includes a read only memory (ROM) 408 or other static storage device coupled to bus 402 for storing static information and instructions for processor 404. A storage device 410, such as a magnetic disk, optical disk, USB thumb drive (Flash drive), or the like, is provided and coupled to bus 402 for storing information and instructions.

The computer system 400 may be coupled via bus 402 to a display 412, such as a liquid crystal display (LCD) (or touch screen), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. In some examples, the same direction information and command selections as cursor control may be implemented via receiving touches on a touch screen without a cursor.

The computing system 400 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 400 may implement the techniques described herein using customized hard-wired logic, one or more ASICs or FPGAs, firmware and/or program logic which in combination with the computer system causes or programs computer system 400 to be a special-purpose machine. According to one example of the disclosed technology, the techniques herein are performed by computer system 400 in response to processor(s) 404 executing one or more sequences of one or more instructions contained in main memory 406. Such instructions may be read into main memory 406 from another storage medium, such as storage device 410. Execution of the sequences of instructions contained in main memory 406 causes processor(s) 404 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 410. Volatile media includes dynamic memory, such as main memory 406. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 402. Transmission media can also take the form of acoustic or light waves, such as those generated during radio-wave and infra-red data communications.

The computer system 400 also includes a network interface 418 (also referred to as a communication interface) coupled to bus 402. Network interface 418 provides a two-way data communication coupling to one or more network links that are connected to one or more local networks. For example, communication interface 418 may be an integrated services digital network (ISDN) card, cable modem, satellite modem, or a modem to provide a data communication connection to a corresponding type of telephone line. As another example, network interface 418 may be a local area network (LAN) card to provide a data communication connection to a compatible LAN (or WAN component to communicated with a WAN). Wireless links may also be implemented. In any such implementation, network interface 418 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through network interface 418, which carry the digital data to and from computer system 400, are example forms of transmission media.

The computer system 400 can send messages and receive data, including program code, through the network(s), network link and network interface 418. In the Internet example, a server might transmit a requested code for an application program through the Internet, the ISP, the local network and the network interface 418.

The received code may be executed by processor 404 as it is received, and/or stored in storage device 410, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 400.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

Aspects and embodiments of the present disclosure may use machine learning. Machine learning is a subfield of artificial intelligence, which, to persons of ordinary skill of the art, corresponds to underlying algorithms and/or frameworks (commonly known as “neural networks” or “machine learning models”) that are configured and/or trained to perform and/or automate one or more tasks or computing processes. For simplicity, the terms “neural networks” and “machine learning models” can be used interchangeably and can be referred to as either “networks” or “models” in short.

Aspects and embodiments of the present disclosure may use deep learning. Deep learning is a subfield of artificial intelligence and machine learning, which, to persons of ordinary skill of the art, corresponds to multilayered implementations of machine learning (commonly known as “deep neural networks”). For simplicity, the terms “machine learning” and “deep learning” can be used interchangeably.

As known to a person of ordinary skill in the art, machine learning is commonly utilized for performing and/or automating one or more tasks such as identification, classification, determination, adaptation, grouping, and generation, among other things. Common types (e.g., classes or techniques) of machine learning include supervised, unsupervised, regression, classification, reinforcement, and clustering, among others.

Among these machine learning types are a number of model implementations, such as linear regression, logistic regression, evolution strategies (ES), convolutional neural networks (CNN), deconvolutional neural networks (DNN), generative adversarial networks (GAN), recurrent neural networks (RNN), and random forest, among others. As known to a person of ordinary skill in the art, one or more machine learning models can be configured and trained for performing one or more tasks at runtime of the model.

As known to a person of ordinary skill in the art, the output of a machine learning model is based at least in part on its configuration and training data. The data that models are trained on (e.g., training data) can include one or more data types. In some embodiments, the training data of a model can be changed, updated, and/or supplemented throughout training and/or inference (i.e., runtime) of the model.

The systems, methods, and/or computing systems, devices, or components of the present disclosure can include machine learning modules. A “machine learning module” is a software module and/or hardware module including computer-executable instructions to configure, train, and/or deploy (e.g., execute) one or more machine learning models.

By way of example and not limitation, a video game as used herein refers to a video game application comprising computer executable instructions that, when executed by a computing device, provide a virtual interactive environment for gameplay, such as by users or players of the video game. In some embodiments, one or more video game applications are accessible through a video game platform. As a non-limiting illustrative example, a video game platform is a software that enables users or players to manage or access video game applications and/or video game content, among other things.

As known to a person of ordinary skill in the art, a game engine uses data (e.g., state data, render data, simulation data, audio data, and other data types of the like) to generate and/or render one or more outputs (e.g., visual output, audio output, and haptic output) for one or more computing devices. In some embodiments, a game engine includes underlying frameworks and software for generating, simulating, or rendering one or more aspects of gameplay. As a non-limiting descriptive example, a game engine includes, among other things, a renderer, simulator, an audio engine, and a stream layer.

A renderer is a graphics framework that manages the rendering of graphics corresponding to lighting, shadows, textures, models, user interfaces, and other aspects of the like among a game engine. A simulator refers to a framework that manages simulation corresponding to physics and other corresponding mechanics-such as those used in part for driving or facilitating animations and/or interactions of gameplay objects, entities, characters, lighting, gasses, and other aspects of the like. A stream layer is a software layer that allows a renderer and simulator to execute independently of one another among a game engine by providing a common execution stream for renderings and simulations to be produced and/or synchronized (e.g., scheduled) at and/or during runtime. An audio engine or audio renderer provides audio playback among one or more audio channels. The output of an audio engine can also correspond to the common execution of a stream layer, for synchronization with rendering and simulation during runtime.

In some embodiments, the data of a video game includes state data, simulation data, rendering data, audio data, animation data, and other data of the like used and/or produced by or among a game engine during runtime execution.

State data is commonly known as data describing a state of a player character, virtual interactive environment, and/or other virtual objects, actors, or entities—in whole or in part—at one or more instances or periods of time during a game session of a video game. For example, state data can include the current location and condition of one or more player characters among a virtual interactive environment at a given time, frame, or duration of time or number of frames.

Simulation data is commonly known as the underlying data corresponding to the simulation (e.g., physics and other corresponding mechanics) of a character or object in a game engine. For example, simulation data can include the joint and structural configuration of a character model and corresponding physical forces or characteristics applied to it at an instance or period of time during gameplay, such as a “frame”, to create animations, among other things.

Render Data is commonly known as the underlying data corresponding to rendering aspects (e.g., visual and auditory rendering) of a game session, which are rendered (e.g., for output to an output device) by a game engine. For example, render data can include data corresponding to the rendering of graphical, visual, auditory, and/or haptic output of a video game, among other things.

Digital game assets (or game assets in short) can include virtual objects, character models, actors, entities, geometric meshes, textures, terrain maps, animation files, audio files, digital media files, font libraries, visual effects, and other digital assets commonly used in video games of the like.

In some embodiments, a game session or gameplay is based in part on the data of a video game. One or more aspects of gameplay (e.g., rendering, simulation, state, interactions of player characters) uses, produces, generates, and/or modifies game data. Likewise, gameplay events, objectives, triggers, and other aspects, objects, or elements of the like also use, produce, generate, and/or modify data of a video game.

The data of a video game may be updated, versioned, and/or stored periodically as a number of files to a computing device. Additionally, game data, or copies and/or portions thereof, can be stored, referenced, categorized, or placed into a number of buffers or storage buffers. A buffer can be configured to capture particular data, or data types of game data for processing and/or storage.

As used herein in some embodiments, video game applications can also use and/or include Software Development Kits (SDKs), Application Program Interfaces (APIs), Dynamically Linked Libraries (DLLs), and other software libraries, components, modules, shims, or plugins that provide and/or enable a variety of functionality; such as—but not limited to—graphics, audio, font, or communication support, establishing and maintaining service connections, performing authorizations, and providing anti-cheat and anti-fraud monitoring and detection, among other things.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A method comprising:
obtaining a plurality of facial expression scans of a subject;
aligning the plurality of facial expression scans to a common coordinate system;
generating a stable hull based on an intersection of the plurality of facial expression scans aligned to the common coordinate system; and
performing rigid stabilization of at least one facial expression scans of the subject by aligning the at least one facial expression scan to the stable hull and removing rigid transformations from the at least one facial expression scan caused by head motion of the subject.

2. The method of claim 1, wherein obtaining the plurality of facial scans comprises:
capturing the plurality of facial expression scans as one or more of: 3D point clouds or polygon meshes.

3. The method of claim 1, wherein aligning the plurality of facial expression scans to a common coordinate system comprises:
computing a bounding cube for each facial expression scan of the plurality of facial expression scans; and
defining the common coordinate system by aligning the bounding cubes for the plurality of facial expression.

4. The method of claim 1, further comprising:
creating a voxel mesh of the plurality of facial expression scans by generating a voxel grid for each facial expression scan of the plurality of facial expression scans and overlapping the voxel grids within the common coordinate system; and
determining, for each voxel grid, whether each voxel is inside or outside of the voxel mesh.

5. The method of claim 4, wherein determining, for each voxel grid, whether each voxel is inside or outside of the voxel mesh comprises executing a Fast Winding Number algorithm on the plurality of facial expressions aligned to the common coordinate system.

6. The method of claim 4, further comprising:
computing distances between each voxels, from each voxel grid, and the voxel mesh,
wherein generating the stable hull is based voxels, from each voxel grid, having the smallest computed distances to the voxel mesh.

7. The method of claim 6, wherein the stable hull comprises a zero isosurface of a maximum function across the compute distances.

8. The method of claim 6, wherein the computing the distance comprises computing signed distance fields for the plurality of plurality of facial expression scans.

9. The method of claim 1, wherein generating the stable hull comprises:
computing a zero isosurface of the intersection of the plurality of facial expression scans aligned to the common coordinate system; and
extracting the zero isosurface as a 3D shape.

10. The method of claim 9, wherein extracting the zero isosurfaces is performed based on a differentiable isosurface extraction method that simultaneously optimizes the stable hull and optimizes transformations for rigid stabilization.

11. A system, comprising:
a memory storing instructions; and
a processor communicatively coupled to the memory and configured to execute the instructions to:
obtain a plurality of facial expression scans of a subject;
align the plurality of facial expression scans to a common coordinate system;
generate a stable hull based on an intersection of the plurality of facial expression scans aligned to the common coordinate system; and
perform rigid stabilization of at least one facial expression scans of the subject by aligning the at least one facial expression scan to the stable hull and removing rigid transformations from the at least one facial expression scan caused by head motion of the subject.

12. The system of claim 11, wherein obtaining the plurality of facial scans comprises:
capturing the plurality of facial expression scans as one or more of: 3D point clouds or polygon meshes.

13. The system of claim 11, wherein aligning the plurality of facial expression scans to a common coordinate system comprises:
computing a bounding cube for each facial expression scan of the plurality of facial expression scans; and
defining the common coordinate system by aligning the bounding cubes for the plurality of facial expression.

14. The system of claim 11, wherein the processor is further configured to execute the instructions to:
create a voxel mesh of the plurality of facial expression scans by generating a voxel grid for each facial expression scan of the plurality of facial expression scans and overlapping the voxel grids within the common coordinate system; and
determine, for each voxel grid, whether each voxel is inside or outside of the voxel mesh.

15. The system of claim 14, wherein determining, for each voxel grid, whether each voxel is inside or outside of the voxel mesh comprises executing a Fast Winding Number algorithm on the plurality of facial expressions aligned to the common coordinate system.

16. The system of claim 14, wherein the processor is further configured to execute the instructions to:
compute distances between each voxels, from each voxel grid, and the voxel mesh,
wherein generating the stable hull is based voxels, from each voxel grid, having the smallest computed distances to the voxel mesh.

17. The system of claim 16, wherein the stable hull comprises a zero isosurface of a maximum function across the compute distances.

18. The system of claim 16, wherein the computing the distance comprises computing signed distance fields for the plurality of plurality of facial expression scans.

19. The system of claim 11, wherein generating the stable hull comprises:
computing a zero isosurface of the intersection of the plurality of facial expression scans aligned to the common coordinate system; and
extracting the zero isosurface as a 3D shape.

20. The system of claim 19, wherein extracting the zero isosurfaces is performed based on a differentiable isosurface extraction method that simultaneously optimizes the stable hull and optimizes transformations for rigid stabilization.
